(19) United States
(12) Patent Application Publication
(10) Pub. No.: US 2026/0261632 A1
(43) Pub. Date: Sep. 3, 2026

(54) SYSTEMS AND METHODS FOR PROJECTION MAPPING ONTO FLOWABLE TEXTILES IN AN ENTERTAINMENT ENVIRONMENT

(71) Applicant: Universal City Studios LLC, Universal City, CA (US)

(72) Inventors: Bryan Zebleckes, Orlando, FL (US); Clarisse Falls, Orlando, FL (US); Benjamin Lowe, Orlando, FL (US); Magdalena Baker, Orlando, FL (US); Christopher Layfield, Orlando, FL (US); Duncan Fewkes, Orlando, FL (US); Michael Brister, Orlando, FL (US); Hallam Knightraven, Orlando, FL (US); Jahaziel Minor, Orlando, FL (US)

(21) Appl. No.: 19/555,399

(22) Filed: Mar. 3, 2026

Related U.S. Application Data
(60) Provisional application No. 63/766,082, filed on Mar. 3, 2025.
(60) Provisional application No. 63/989,151, filed on Feb. 23, 2026.

(51) Int. Cl. H04N 9/31

(52) U.S. Cl. CPC H04N 9/31

(57) ABSTRACT

An attraction system may include a show element with a body, a textile that covers at least a portion of the body, and multiple trackers coupled to the textile. The attraction system also includes a processing system with one or more processors and memory storing instructions executable by the processing system to cause the processing system to process tracking data to determine respective positions of the multiple trackers, and instruct a projector to project image data onto the textile based on the respective positions of the multiple trackers.

### CROSS-REFERENCE TO RELATED APPLICATIONS

This application claims priority to and the benefit of U.S. Provisional Application No. 63/766,082, entitled “SYSTEMS AND METHODS FOR PROJECTION MAPPING ONTO FLOWABLE TEXTILES IN AN ENTERTAINMENT ENVIRONMENT” and filed Mar. 3, 2025, and also claims priority to and the benefit of U.S. Provisional Application No. 63/989,151, entitled “SYSTEMS AND METHODS FOR PROJECTION MAPPING ONTO FLOWABLE TEXTILES IN AN ENTERTAINMENT ENVIRONMENT” and filed Feb. 23, 2026, each of which is incorporated by reference in its entirety for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Amusement parks and other entertainment environments may include animated figures to entertain guests. Certain animated figures may be brought to life by projection mapping, which traditionally directs predetermined appearances onto the animated figures. For example, a particular animated figure may be visually supplemented with a canned or fixed set of images projected by an internally-positioned projector that projects the images through a semi-transparent projection surface of the particular animated figure. It is presently recognized that advances may be made to provide improved immersive experiences for the guests.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In an embodiment, an attraction system may include a show element with a body, a textile that covers at least a portion of the body, and multiple trackers coupled to the textile. The attraction system also includes a processing system with one or more processors and memory storing instructions executable by the processing system to cause the processing system to process tracking data to determine respective positions of the multiple trackers, and instruct a projector to project image data onto the textile based on the respective positions of the multiple trackers.

In an embodiment, an attraction system includes a processing system with one or more processors and memory storing instructions executable by the processing system to cause the processing system to process tracking data to determine respective positions of multiple trackers coupled to a flowable textile of a show element; determine a configuration of the flowable textile based on the respective positions of the multiple trackers; and instruct a projector to project image data onto the flowable textile based on the determined configuration of the flowable textile.

In an embodiment, a method includes receiving, at one or more processors, tracking data from multiple trackers coupled to a flowable textile, one or more detectors configured to detect the multiple trackers coupled to the flowable textile, or both. The method also includes determining, using the one or more processors, respective positions of the multiple trackers based on the tracking data. The method further includes determining, using the one or more processors, a configuration of the flowable textile based on the respective positions of the multiple trackers. The method further includes instructing, using the one or more processors, a projector to project image data onto the flowable textile based on the determined configuration of the flowable textile.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an embodiment of an attraction system, in accordance with the present disclosure;

FIG. 2 is a schematic diagram of multiple example inputs that may be processed to generate a projection output as part of the attraction system of FIG. 1, in accordance with the present disclosure;

FIG. 3 is a front view of an embodiment of a show element that may be used in the attraction system of FIG. 1, in accordance with the present disclosure;

FIG. 4 is a front view of an embodiment of a show element that may be used in the attraction system of FIG. 1, wherein a textile of the show element includes support features, in accordance with the present disclosure;

FIG. 5 is a back view of the embodiment of the show element of FIG. 4, in accordance with the present disclosure;

FIG. 6 is a side view of the embodiment of the show element of FIG. 4, in accordance with the present disclosure; and

FIG. 7 is a cross-sectional view of an embodiment of a portion of the textile of the show element of FIG. 4, in accordance with the present disclosure.

### DETAILED DESCRIPTION

When introducing elements of various embodiments of the present disclosure, the articles “a,” “an,” and “the” are intended to mean that there are one or more of the elements. The terms “comprising,” “including,” “having,” and “based on” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure relates generally to a show effect system for an entertainment environment, such as an amusement park, theatre, sports arena, museum, hotel, restaurant, and so forth. The entertainment environment may include an attraction, such as a ride, haunted house, escape room, performance stage, maze, and so forth. In the attraction, one or more projectors may project imagery onto an external surface of a show element (e.g., show prop; tangible show element), such as a costume, an animated figure, a building, and/or any other structure of the attraction. By projection mapping onto the external surface of the show element, the show element may provide a variety of special effects and/or change appearance over time. For example, the show element may include or be coupled to a textile (e.g., fabric, cloth, flowing material), and the projection mapping may be used to dynamically change appearance of the textile to create a costume-changing illusion. In an embodiment, the show element may include an animated figure at least partially covered by (e.g., wearing; clothed by) the textile, and the projection mapping may be used to dynamically change appearance of the textile to create the costume-changing illusion before, after, and/or during movement of a body of the animated figure. For example, at least a portion of the body of the animated figure (e.g., one or more arms of the body of the animated figure) may move within the entertainment environment and/or relative to another portion of the body of the animated figure, which may cause the textile to move (e.g., shift; change configuration or shape) within the entertainment environment and/or relative to the body of the animated figure. In these cases, the projection mapping may be used to dynamically change appearance of the textile to create the costume-changing illusion before, after, and/or during the movement of the body of the animated figure.

In such cases, a controller (e.g., electronic controller) may receive and process tracking data from one or more trackers that are coupled to the textile to determine respective positions of the one or more trackers that are coupled to the textile, such as in real time (e.g., real time and/or substantially real time). Further, based on the respective positions of the one or more trackers, the controller may determine (e.g., predict; estimate) a textile position (e.g., configuration; shape) in real time (e.g., real time and/or substantially real time) and/or at a future time (e.g., within milliseconds, hundredths of seconds, tenths of seconds, or one or more seconds). It should be appreciated that the textile position in real time may also be referred to herein as a current textile position at a current time. It should be appreciated that the textile position at the future time may also be referred to herein as a future textile position at the future time. In any case, the controller may determine the textile position of an entirety of the textile and/or at least a portion of the textile, such as at least a portion of the textile that is viewable by guests. Then, the controller may instruct the one or more projectors to project the imagery onto the textile in accordance with the textile position to accurately map the imagery to the textile.

In an embodiment, the controller may also receive and process additional inputs that may affect the textile (e.g., cause movement of the textile), and the controller may use the additional inputs to determine the textile position in real time and/or at the future time. For example, the additional inputs may include operational inputs related to a ride vehicle (e.g., a position of the ride vehicle, such as a current position and/or a planned position of the ride vehicle), additional show effects systems (e.g., additional show elements, wind effects, haptic effects, sound effects), and/or environmental systems (e.g., heating, ventilation, and air conditioning (HVAC) systems, doors, maintenance systems).

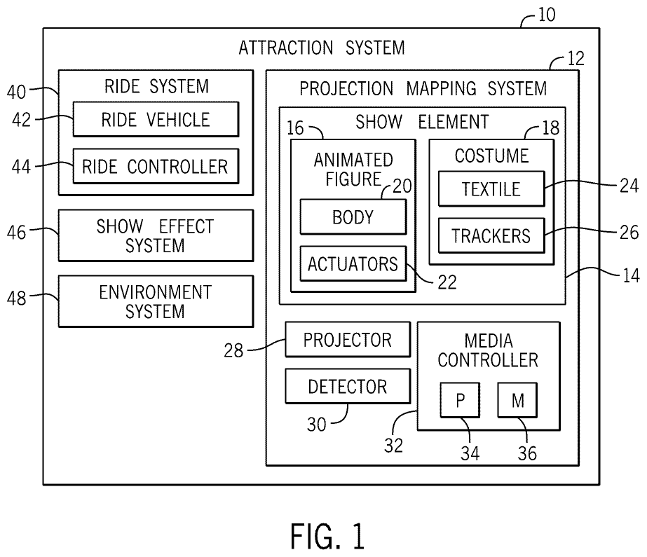

FIG. 1 is a block diagram of an embodiment of an attraction system 10, which may be used in an entertainment environment, such as an amusement park, theatre, sports arena, museum, hotel, restaurant, and so forth. The attraction system 10 may include a projection mapping system 12. The projection mapping system 12 may include a show element 14, which may include an animated FIG. 16 and a costume 18 (e.g., accessory; cover; layer). The animated FIG. 16 may include a body 20, which may have any suitable form (e.g., appearance of a human, an animal, a magical creature, a decorative object; a support frame). In an embodiment, the animated FIG. 16 may also include one or more actuators 22 that operate to move the body 20 within the entertainment environment and/or that operate to move one portion of the body 20 relative to another portion of the body 20. The costume 18 may include a textile 24, which may have any suitable form (e.g., appearance of clothing, such as a dress, a skirt, a shirt, a hat; appearance of a decorative feature, such as a curtain, a blanket, a flag). In an embodiment, the costume 18 may also include or be coupled to one or more trackers 26 that enable tracking respective positions of the one or more trackers 26, and thus enable tracking respective positions of portions of the textile 24 (e.g., the respective portions of the textile 24 co-located with and/or coupled to the one or more trackers 26). Because the respective positions of the one or more trackers 26 may be tracked over time (e.g., continuously, periodically, and/or responsive to events over time), the one or more trackers 26 enable tracking the respective positions of the portions of the textile 24 over time. The one or more trackers 26 may each be placed at a known location of the textile 24 (e.g., associated with a particular location or coordinate of the textile 24).

While FIG. 1 illustrates the show element 14 with the animated FIG. 16 and the costume 18 to facilitate discussion of one example, it should be appreciated that techniques disclosed herein may be utilized with and/or adapted to project imagery (e.g., image data) onto any dynamic material (e.g., flowable or flexible material, such as a flowable textile material) and/or any dynamic object (e.g., freely moving object, such as an object suspended from a ceiling). For example, the techniques disclosed herein may be utilized within and/or adapted to project imagery onto any dynamic feature (e.g., the costume 18, the flowable or flexible material, the freely moving object, the object suspended from the ceiling) that is expected to demonstrate variable position (e.g., variable configuration and/or shape; changes in relative positions between portions) over time and/or that is expected to demonstrate variable surface appearance (e.g., texture, folds) over time. Further, the dynamic feature may be expected to demonstrate variable position over time and/or variable surface appearance over time even when exposed to same or similar forces over time (e.g., movement of an underlying and/or connected structure; due to external factors, such as environmental factors, such as air flow, vibrations, and so forth; over repeated cycles in the attraction system 10). For example, the dynamic feature may be a textile flag that is expected to wave in one manner that results in one sequence of positions and/or appearances (e.g., wrinkles; undulations), and then the textile flag is expected to wave in another manner that results in another sequence of positions and/or appearances (e.g., wrinkles; undulations).

It should be appreciated that the animated FIG. 16, the costume 18, any support structure, and/or any dynamic feature may or may not include on-board actuators and/or may or may not be driven to move via actuators. For example, the dynamic feature may be a textile flag with one or more on-board actuators sewn into a fabric and operated to provide a waving effect, or the dynamic feature may be a textile flag without any on-board actuators and that is merely formed of loose fabric that is freely suspended from a flag support structure (which may or may not include on-board actuators).

Thus, as used herein, the animated FIG. 16 may be any type of show element feature, such as a show set piece, a robotic figure, a decorative object, a support structure, or any other suitable type of object or item that is positioned in the entertainment environment. Additionally, the costume 18 may be any type of show element feature, such as a handheld object, a portable object, a worn object, an article of clothing, an accessory item, a decorative item, or any other suitable type of object or item that is associated with the animated FIG. 16 and/or that is otherwise positioned in the entertainment environment. For example, the costume 18 may include a flexible paper that is carried by the animated FIG. 16, the costume 18 may include a dress that is worn by the animated FIG. 16, or the costume 18 may include a curtain suspended from a wall that forms part of the entertainment environment.

The projection mapping system 12 may also include one or more projectors 28 and/or one or more detectors 30 (e.g., cameras, image sensors, radiofrequency readers). The one or more projectors 28 may be configured to project imagery (e.g., image data) onto the textile 24. The one or more detectors 30 may be configured to detect the multiple trackers 26 and to generate tracking data indicative of respective positions of the multiple trackers 26. The projection mapping system 12 may also include a media controller 32 (e.g., electronic controller) that includes a processor 34 and memory 36.

The multiple trackers 26 may include passive markers and/or active sensors. For example, the multiple trackers 26 may include passive markers (e.g., retroflectors; passive radiofrequency identification tags) that are detectable by the one or more detectors 30. As another example, the multiple trackers 26 may include active trackers (e.g., powered trackers; accelerometers; inertial measurement units; light emitters; light detectors, active radiofrequency identification tags) that output tracking data and/or that are detectable by the one or more detectors 30. The multiple trackers 26 may be coupled to the textile 24, such as on an external surface of the textile 24 (e.g., for line of sight to the one or more detectors 30), between layers of the textile 24 (e.g., to hide from view of guests, while enabling radiofrequency communication), and/or on an internal surface of the textile 24 (e.g., to hide from view of guests, while enabling radiofrequency communication and also wired connections to another device, such as a power supply, data storage unit, and/or the media controller 32).

In an embodiment, the multiple trackers 26 may be on the external surface of the textile 24, but designed to blend into the textile 24 (e.g., via paint to match the textile 24; via an appearance of functional and/or decorative details for the textile 24, such as buttons for the textile 24). Further, in some such cases, a gasket or support ring may extend from the external surface of the textile 24 to the internal surface of the textile 24 to enable the multiple trackers 26 to be on the external surface of the textile 24 and also to have the wired connection to another device. In an embodiment, all of the multiple trackers 26 or a percentage of the multiple trackers 26 (e.g., at least 25, 50, 75, or 90 percent) may be positioned on a back side (e.g., back side portion) of the textile 24 (e.g., facing away from the guests that will view the textile 24). In this way, the multiple trackers 26 are not visible to the guests and enable collection of tracking data that may be processed to determine (e.g., estimate, predict) a textile position of the textile 24 in real time and/or a future time. In particular, the tracking data may be processed to determine the textile position of an entirety of the textile 24 and/or at least a portion of the textile 24, such as at least a front side (e.g., front side portion) of the textile 24 (e.g., facing toward the guests that will view the textile 24).

The one or more projectors 28 may project imagery onto the textile 24, such as onto at least the portion of the textile 24. The one or more projectors 28 may project the imagery onto the textile 24 in a timed manner based on the determined textile position of the textile 24 in real time and/or the future time. As such, the one or more projectors 28 may project the imagery to provide colors, textures, and/or other image features that match a geometry or a contour of the textile 24, and may do so even as the geometry or the contour of the textile 24 changes over time (e.g., due to movement of the body 20 of the animated FIG. 16 that supports the textile 24). The one or more projectors 28 may be configured to present different imagery (e.g., different colors, patterns, themes) on the textile 24 at different times of the projection mapping operation in the attraction system 10, such as to simulate certain movements of the textile 24, costume changes, theme changes, storyline changes, and the like.

The one or more projectors 28 and/or the one or more detectors 30 may be hidden or concealed from the guests as the guests view the show element 14. In an embodiment, the one or more projectors 28 and the one or more detectors 30 may be physically coupled to one another. For example, the one or more projectors 28 and the one or more detectors 30 may be coupled to one another and/or to a frame (e.g., rigid frame) to form a unified system. In certain instances, the one or more projectors 28 and the one or more detectors 30 may be rigidly mounted to one another and/or to the frame so that the two remain in fixed positions relative to one another. In this way, the one or more projectors 28 and the one or more detectors 30 may be calibrated to and fixed to a common coordinate system.

The media controller 32 may be communicatively coupled (e.g., via one or more wires, via wireless communication (e.g., via transmitters, receivers, transceivers)) to the show element 14 (e.g., to the one or more actuators 22 and/or to the one or more trackers 26), the one or more projectors 28, and/or the one or more detectors 30. The media controller 32 may include the processor 34 (representative of one or more processors) and the memory 36 (representative of one or more memories). The memory 36 may include volatile memory, such as random-access memory (RAM), and/or non-volatile memory, such as read-only memory (ROM), optical drives, hard disc drives, solid-state drives, or any other non-transitory computer-readable medium that includes instructions to operate the projection mapping system 12. The processor 34 may be configured to execute such instructions. For example, the processor 34 may include one or more application specific integrated circuits (ASICs), one or more field programmable gate arrays (FPGAs), one or more general-purpose processors, or any combination thereof.

While certain examples and processing configurations are described herein to facilitate discussion, it should be appreciated that the actions described herein may be distributed between multiple processors (e.g., as part of a processing system). For example, the processor 34 of the media controller 32 may include one or more processors that may operate together with one or more processors of another controller to carry out any suitable actions described herein. As another example, the processor 34 of the media controller 32 may include multiple processors that may operate together to carry out any suitable actions described herein. Accordingly, terms such as “controller,” “control system,” “computing system,” “processing system,” and/or “processing circuitry” as used herein may refer to any variation and/or configuration of one or more processors, one or more memories, and/or one or more controllers that operate together in any suitable manner to carry out disclosed techniques.

In operation, the media controller 32 may receive the tracking data from the one or more trackers 26 and/or the one or more detectors 30. The media controller 32 may process the tracking data to determine the respective positions of the one or more trackers 26. Further, the media controller 32 may process the tracking data to determine (e.g., estimate; predict) the textile position in real time and/or at the future time. For example, the media controller 32 may utilize one or more algorithms, such as machine learning algorithms, to estimate the textile position in real time and/or to predict the textile position at the future time based on the tracking data (e.g., based on the respective positions of the one or more trackers 26). It should be appreciated that to estimate and/or to predict the textile position may include estimating and/or predicting respective positions of portions of the textile 24 that are physically separate from and/or are not co-located with the one or more trackers 26 (e.g., such portions of the textile 24 may include an edge portion of the textile 24, even though the one or more trackers 26 are offset from the edge portion of the textile 24; a projection surface portion of the textile 24, even though the one or more trackers 26 are offset from the projection surface portion of the textile 24).

Further, the media controller 32 may utilize the one or more algorithms, such as the machine learning algorithms, to intake the tracking data over time (e.g., new tracking data; intake the tracking data continuously, periodically, and/or responsive to events). Thus, the media controller 32 may determine (e.g., update, estimate, predict) the textile position in real time over time and/or the future time over time. For example, the media controller 32 may receive first tracking data at a first time, and then process the first tracking data to determine a first textile position (e.g., in real time and/or at a respective future time). Additionally, the media controller 32 may receive second tracking data at a second time after the first time, and then process the second tracking data to determine a second textile position (e.g., in real time and/or at a respective future time). Thereafter, the media controller 32 may receive third tracking data at a third time after the second time, and then process the third tracking data to determine a third textile position (e.g., in real time and/or at a respective future time), and so on. In this way, the media controller 32 may determine (e.g., update) the textile position over time.

The machine learning algorithms may be trained on training data, including historical tracking data and/or modeled data. For example, the training data may include historical tracking data with corresponding ground truth data representative of the textile position in real time and/or the future time (e.g., for each set of historical tracking data, such as for each set of the respective positions of the one or more trackers 26, the corresponding ground truth data includes the textile position in real time and/or at the future time).

Additionally, the media controller 32 may generate, access, and/or transmit imagery to the one or more projectors 28 for projection mapping. The media controller 32 may, for example, instruct the one or more projectors 28 to project the imagery on the textile 24 based on the tracking data, such as based on the textile position derived from the tracking data. The imagery may match the textile position, such that the imagery corresponds to the geometry or contour of the textile 24 (e.g., covers at least the front side of the textile 24; covers at least the projection surface portion 70 of the textile 24; aligns with an overall profile of the textile 24 at least from a perspective of the guests). Further, the media controller 32 may generate, access, and/or transmit the imagery to the one or more projectors 28 in a dynamic manner, such that the imagery changes as the textile 24 moves in the entertainment environment, and such that the imagery continues to match the textile position derived from the tracking data over time. In this way, the projection mapping system 12 may provide a dynamic and realistic appearance of the textile 24, and thus, of the costume 18 and the show element 14.

As described herein, the media controller 32 may receive, access, process, and/or account for other data inputs (e.g., additional data inputs) to determine the textile position. For example, the media controller 32 may receive data inputs indicative of a show to be performed and/or being performed by the animated FIG. 16 (e.g., one or more movements, such as a series of movements, implemented by the one or more actuators 22). As shown in FIG. 1, the media controller 32 may instruct movement of the animated FIG. 16 (e.g., via control signals to the one or more actuators 22). In an embodiment, the one or more projectors 28 may be controlled to project the imagery onto the textile 24 in coordination with the movement of the animated FIG. 16, such as to present projected visual effects in coordination with the movement of the animated FIG. 16 (e.g., to present a costume change in coordination with an arm gesture of the animated FIG. 16, to change a theme in coordination with a stomping motion of the animated FIG. 16, and so forth), such as to enhance an immersive experience of the guests within the attraction system 10.

Additionally or alternatively, the attraction system 10 may include a ride system 40 that may include one or more ride vehicles 42 and a ride controller 44 (e.g., electronic controller). In an embodiment, the media controller 32 may receive data inputs indicative of one or more operational characteristics of the one or more ride vehicles 42. For example, the one or more operational characteristics of the one or more ride vehicles 42 may include respective positions of the one or more ride vehicles 42 (e.g., a current position and/or a planned position of at least one of the one or more ride vehicles 42) relative to the show element 14, respective travel speeds of the one or more ride vehicle 42 (e.g., a current speed and/or a planned speed of at least one of the one or more ride vehicles 42, such as while placing the guests in a viewing range of the show element 14), and so forth. In an embodiment, the animated FIG. 16 may be controlled to move and/or the one or more projectors 28 may be controlled to project the imagery onto the textile 24 in coordination with movement of the one or more ride vehicles 42, such as to present projected visual effects in coordination with operation (e.g., movement) of the one or more ride vehicles 42 (e.g., to present a costume change as at least one of the ride vehicles 42 carries the guests in the viewing range of the show element 14, to change a theme as at least one of the ride vehicles 42 accelerates toward the show element 14, and so forth), such as to enhance an immersive experience of the guests within the attraction system 10. For example, the animated FIG. 16 may be controlled to carry out a particular movement (e.g., a lean of the body 20, a motion of arms of the body 20, and/or other movement) and/or the one or more projectors 28 may be controlled to project the imagery onto the textile 24 while the at least one of the ride vehicles 42 is stopped to place the guests in the viewing range of the show element 14 (e.g., at a scene with the show element 14) to enable the guests to view the particular movement and/or the costume change. In an embodiment, the at least one of the ride vehicles 42 may move at a reduced speed through the scene (e.g., a relatively low speed compared to before and/or after the scene) to enable the guests to view the particular movement and/or the costume change. In an embodiment, the at least one of the ride vehicles 42 may stop at the scene and/or move at the reduced speed through the scene to enable the guests to view the particular movement and/or the costume change, and then the at least one of the ride vehicles 42 may move at an increased speed (e.g., begin moving from a stopped position; accelerate from the relatively low speed) after the particular movement and/or the costume change. It should be appreciated that the costume change may be a full or partial costume change, and the attraction system 10 may operate such that the guests view an entirety or a portion of the costume change. In an embodiment, the imagery being projected by the one or more projectors 28 may be adjusted (e.g., squinched) based on respective positions of the one or more ride vehicles 42. For example, the media controller 32 may generate and/or transmit instructions to the one or more projectors 28 to squinch the imagery based on a respective positions of the one or more ride vehicles 42 as the one or more ride vehicles 42 carry the guests in the viewing range of the show element 14.

Additionally or alternatively, the attraction system 10 may include a show effect system 46 that may include one or more show effect devices, such as one or more additional animated figures, light sources that provide lighting effects, speakers that provide sound effects, haptic devices (e.g., vibration devices) that provide haptic effects, and so forth. In an embodiment, the show effect system 46 may include a show effect controller to control operations of the one or more show effect devices. In an embodiment, the media controller 32 may receive data inputs indicative of one or more operational characteristics of the show effect system 46. For example, the one or more operational characteristics of the show effect system 46 may include respective positions of the one or more show effect devices (e.g., a current position and/or a planned position of at least one of the one or more show effect devices) relative to the show element 14, respective effects provided by the one or more show effect devices (e.g., a current effect and/or a planned effect output by at least one of the one or more show effect devices), and so forth. In an embodiment, the animated FIG. 16 may be controlled to move and/or the one or more projectors 28 may be controlled to project the imagery onto the textile 24 in coordination with outputs of the show effect system 46, such as to present projected visual effects in coordination with the outputs of the show effect system 46 (e.g., to present a costume change in coordination with a sound output, to change a theme in coordination with a lighting effect, and so forth), such as to enhance an immersive experience of the guests within the attraction system 10.

Additionally or alternatively, the attraction system 10 may include an environment system 48 that may include one or more environment control devices, such as a heating ventilation and air conditioning (HVAC) system, fans, doors, windows, and so forth. The environment system 48 may include an environment controller to control operation of the one or more environment control devices. In an embodiment, the media controller 32 may receive data inputs indicative of one or more operational characteristics of the environment system 48. For example, the one or more operational characteristics of the environment system 48 may include respective positions of the one or more environment control devices (e.g., a current position and/or a planned position of at least one of the one or more environment control devices) relative to the show element 14, respective outputs provided by the one or more environment control devices (e.g., a current output and/or a planned output of at least one of the one or more environment control devices), and so forth. The environment system 48 may or may not be intended to contribute to an immersive experience of the guests within the attraction system 10. For example, the environment system 48 may be operated to provide appropriate climate control for the attraction system 10, but the environment system 48 may result in air flow in a vicinity of the show element 14 (e.g., due to drafts through windows; rotation of fans; air output from the HVAC system).

The media controller 32 may account for the other data inputs because systems, devices, effects, and/or environment control outputs in a vicinity of the textile 24 may cause movement of the textile 24. For example, as the one or more ride vehicles 42 travel by the textile 24, the one or more ride vehicles 42 may move air in the vicinity of the textile 24 in a manner that causes movement of the textile 24. Similarly, operation of speaker, a haptic device, an HVAC system, a fan, opening of a door or a window, and/or movement of another animated figure in the vicinity of the textile 24 may also cause movement of the textile 24. As such, by accounting for the tracking data and the other data inputs, the media controller 32 may accurately determine the textile position in real time and/or the future time.

As set forth herein, the media controller 32 may utilize one or more algorithms, such as machine learning algorithms, to determine the textile position in real time and/or the future time based on the tracking data and the other data inputs. Thus, the machine learning algorithms may be trained on training data, including historical tracking data and/or modeled data indicative of the textile position in real time and/or the future time for particular respective positions of the one or more trackers 26, as well as particular operational characteristics of the animated FIG. 16, the one or more ride vehicles 42, the one or more show effect devices, and/or the one or more environment control devices, for example.

It is presently recognized that the textile 24 may drape and/or move differently over time (e.g., due to stretching, wear, and/or degradation of the textile 24). Further, it is presently recognized that the textile 24 may drape and/or move differently after certain events, such as due to movement of an underlying support structure (e.g., the body 20 of the animated FIG. 16), the one or more ride vehicles 42 traveling by the textile 24 at a high speed, maintenance events in which the textile 24 is manually moved by a maintenance technician, and so forth. For example, after each instance of a particular gesture (e.g., a same gesture, such as an arm wave or a body lean) performed by the body 20 of the animated FIG. 16 (e.g., for each passing ride vehicle of the one or more ride vehicles 42), the textile 24 may be in a slightly different position (e.g., configuration, shape; respective positions of portions of the textile 24 may shift relative to one another and/or relative to the entertainment environment). As such, the media controller 32 may receive, access, process, and/or account for the dynamic nature of the textile 24 and/or for changes that may occur after certain events. Thus, while the machine learning algorithms may learn and/or update over time, certain limitations may be implemented. For example, the maintenance technician may provide an input indicative of a maintenance event and/or the tracking data may indicate occurrence of the maintenance event, and the media controller 32 may disregard recent tracking data (e.g., not use recent tracking data to determine the textile position, such as at least with respect to predicting the future textile position at the future time) and instead return to initial or baseline settings to begin receiving and processing new tracking data (e.g., to determine the textile position, such as at least with respect to predicting the future textile position at the future time).

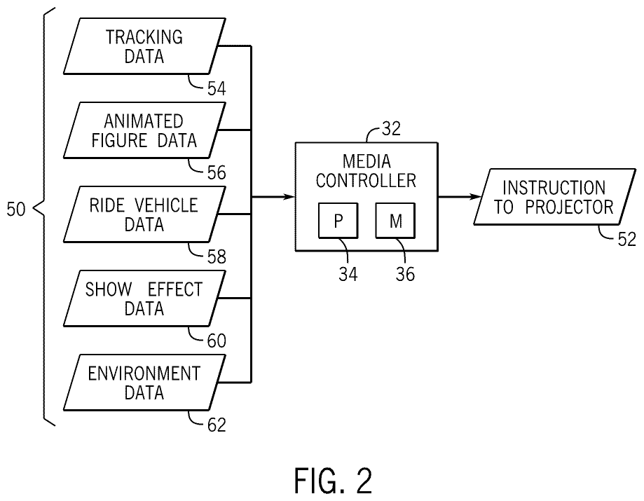

FIG. 2 is a schematic diagram of multiple example inputs 50 that may be processed to generate a projection output 52 as part of the attraction system 10 of FIG. 1, in accordance with the present disclosure. As shown and described herein, the inputs 50 may include tracking data 54, animated figure data 56, ride vehicle data 58, show effect data 60, and/or environment data 62. The tracking data 54 may be based on the one or more trackers 26 of FIG. 1, and the tracking data 54 may indicate the respective positions of the one or more trackers 26 FIG. 1. Further, because the one or more trackers 26 of FIG. 1 are at known locations of the textile 24 of FIG. 1 and/or as a result of appropriate training of machine learning algorithms, the tracking data 54 may indicate the textile position in real time and/or at the future time.

Further, as noted herein, the tracking data 54 may indicate the respective positions of the one or more trackers 26 of FIG. 1 over time. Such respective series of the respective positions of the one or more trackers 26 of FIG. 1 over time may be used as the tracking data 54, as such respective series of the respective positions of the one or more trackers 26 of FIG. 1 over time may indicate and be processed to predict the future textile position of the textile 24 of FIG. 1 at the future time and may be particularly useful during movement of the textile 24 (e.g., a first movement of a first tracker over a time period and a second movement of a second tracker over the time period may indicate a first future textile position at the future time, while a third movement of the first tracker over the time period and a fourth movement of the second tracker over the time period may indicate a second future textile position at the future time).

The animated figure data 56 may indicate a show to be performed and/or being performed by the animated FIG. 16 of FIG. 1 (e.g., one or more movements, such as a series of movements, implemented by the one or more actuators 22 of FIG. 1). The ride vehicle data 58 may indicate one or more operational characteristics of the one or more ride vehicles 42 of FIG. 1, such as respective positions of the one or more ride vehicles 42 of FIG. 1. The show effect data 60 may indicate one or more operational characteristics of the show effect system 46 of FIG. 1. For example, the one or more operational characteristics of the show effect system 46 of FIG. 1 may include respective effects provided by the one or more show effect devices. The environment data 62 may indicate one or more operational characteristics of the environment system 48 of FIG. 1. For example, the one or more operational characteristics of the environment system 48 of FIG. 1 may include respective outputs provided by the one or more environment control devices.

The media controller 32 (e.g., including the processor 34 and the memory 36) may process the inputs to determine the textile position in real time and/or at the future time. As set forth herein, the media controller 32 may utilize one or more algorithms, such as machine learning algorithms, to determine the textile position in real time and/or at the future time based on the inputs 50. As set forth herein, determining the textile position may include determining the textile position of an entirety of the textile 24 of FIG. 1 and/or at least a portion of the textile 24 of FIG. 1. Further, determining the textile position may include determining the textile position of at least a portion of the textile 24 of FIG. 1 that is not co-located with the one or more trackers 26 of FIG. 1. Further, determining the textile position in real time may include estimating the current textile position at the current time, and determining the textile position at the future time may include predicting the future textile position at the future time.

As shown, the media controller 32 may then generate the projection output 52, such as by providing an instruction to the one or more projectors 28 of FIG. 1. In particular, the media controller 32 may generate, access, and/or transmit the imagery for projection by the one or more projectors 28 of FIG. 1. In an embodiment, the media controller may determine the textile position in real time. In such cases, the media controller 32 may immediately generate, access, and/or transmit the imagery for projection by the one or more projectors 28 of FIG. 1. In an embodiment, the media controller may predict the future textile position at the future time (e.g., the future time may be less than or equal to about 0.5 milliseconds, 1 millisecond, 2 milliseconds, 5 milliseconds, 0.1 seconds, 0.2 seconds, 0.5 seconds, 1 second, 2 seconds, or more from a current time). In such cases, the media controller 32 may generate, access, and/or transmit the imagery for projection by the one or more projectors 28 of FIG. 1 at the future time. By predicting the future textile position at the future time, the projection mapping system 12 may be able to (e.g., have sufficient time to) carry out processing steps, instruction steps, and imagery projection steps such that the imagery aligns with the textile 24 at the future time and over time. In this way, the attraction system 10 of FIG. 1 provides a realistic, immersive projection mapping result with the imagery presented on the textile 24 to match the geometry or the contour of the textile 24 at least from the perspective of the guests.

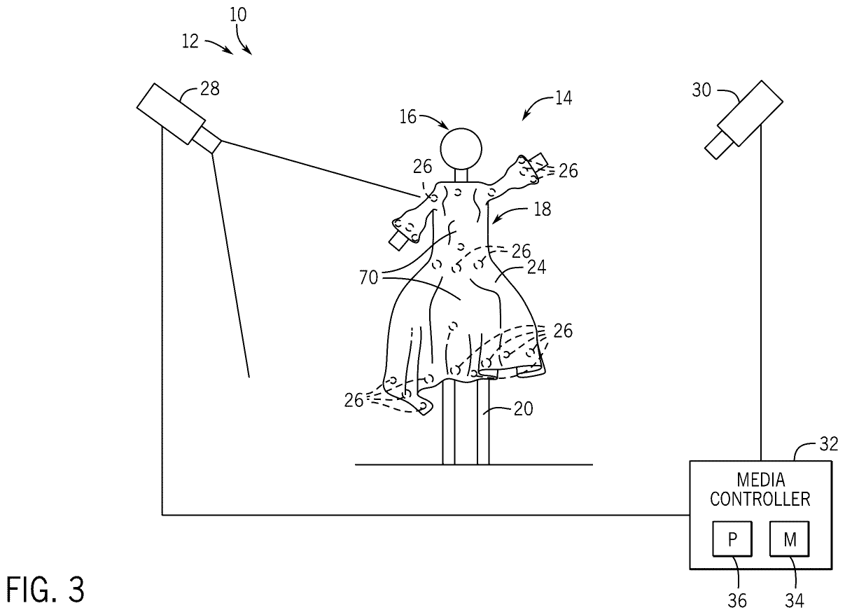

FIG. 3 is a front view of an embodiment of a show element 14 that may be used in the attraction system 10, in accordance with the present disclosure. For example, the front view of the embodiment of the show element 14 may include a front side (e.g., first side; guest-facing side; front side portion) of the show element 14 that is visible to the guests within a guest area (e.g., the guests within a seating area; the guests within a ride vehicle on a ride path; the guests walking along a walking path). Further, a back side (e.g., second side; back side portion) of the show element 14 may be opposite (e.g., generally or substantially opposite) to the front side of the show element 14, and the back side of the show element 14 may not be visible to the guests within the guest area. As shown, the show element 14 may include the animated FIG. 16, which may include the body 20. As described with reference to FIG. 1, the animated FIG. 16 may also include the one or more actuators 22 of FIG. 2 that drive movement of the body 20. As shown, the show element 14 may include the costume 18, which may include the textile 24 and the one or more trackers 26. In FIG. 3, the one or more trackers 26 are shown in dashed lines, as the one or more trackers 26 may be present on the external surface of the textile 24, on the internal surface of the textile 24, between layers of the textile 24, at the back side of the show element 14, and/or at the front side of the show element 14.

While a number of trackers 26 are shown to facilitate discussion, it should be appreciated that the show element 14 may include any suitable number of trackers 26 (e.g., one, two, three, four, five, six, seven, eight, nine, ten, eleven, twelve, thirteen, fourteen, fifteen, twenty, twenty-five, thirty, forty, fifty, one hundred, or more). Further, it should be appreciated that the show element 14 may include the one or more trackers 26 with any suitable spacing (e.g., less than or equal to about 5, 10, 15, 20, 25, 30 centimeters apart) and/or locations (e.g., distributed with more trackers proximate to movable joints of the animated FIG. 16 that are underneath or covered by the textile 24, such as shoulder joints; distributed with more trackers proximate to portions of the textile 24 with more freedom of movement (e.g., a bottom portion of a dress), and less trackers proximate to portions of the textile 24 with less freedom of movement (e.g., a fitted torso portion of the dress)). For example, in FIG. 3, the one or more trackers 26 are distributed with more trackers proximate to portions of the textile 24 with more freedom of movement (e.g., the bottom portion of the dress), and less trackers proximate to portions of the textile 24 with less freedom of movement (e.g., the fitted torso portion of the dress). In an embodiment, the textile 24 may include one or more projection surfaces 70 (e.g., guest-facing surfaces) that are intended to present (e.g., receive; display) imagery projected by the one or more projectors 28. For example, an entirety of a guest-facing side of the textile 24 may form one projection surface 70, or different portions of the guest-facing side of the textile 24 may form different projection surfaces 70 (e.g., distinct).

In some such cases, it may be desirable to position the one or more trackers 26 about the one or more projection surfaces 70 (e.g., to at least partially surround or frame the one or more projection surfaces 70). For example, if a center of the bottom portion of the dress is intended to be one of the one or more projection surfaces 70, then a series of trackers may be positioned along or proximate to a waistline that is above the center of the bottom portion of the dress and another series of trackers may be positioned along or proximate to a bottom edge that is below the center of the bottom portion of the dress. In FIG. 3, at least one tracker is shown in the center of the bottom portion of the dress. While this placement may facilitate tracking the center of the bottom portion of the dress for accurate projection of the imagery onto the center of the bottom portion of the dress, it should be appreciated that the center of the bottom portion of the dress (and the one or more projection surfaces 70, generally) may be devoid of the one or more trackers 26 to provide a smooth and/or continuous textile surface to facilitate visualization of the imagery by the guests.

As set forth herein, in operation, the media controller 32 may receive the tracking data 54 of FIG. 2 from the one or more trackers 26 and/or the one or more detectors 30. The media controller 32 may process the tracking data 54 of FIG. 2 to determine the respective positions of the one or more trackers 26. Further, the media controller 32 may process the tracking data 54 of FIG. 2 to determine the textile position in real time and/or at the future time. For example, the media controller 32 may utilize one or more algorithms, such as machine learning algorithms, to determine the textile position in real time and/or at the future time based on the tracking data 54 of FIG. 2 (e.g., based on the respective positions of the one or more trackers 26).

Additionally, the media controller 32 may generate, access, and/or transmit imagery to the one or more projectors 28 for projection mapping. The media controller 32 may, for example, instruct the one or more projectors 28 to project the imagery on the textile 24 based on the tracking data 54 of FIG. 2, such as based on the textile position indicated by the tracking data 54 of FIG. 2. As described herein, the media controller 32 may receive, access, process, and/or account for multiple data inputs, such as the tracking data 54 of FIG. 2, as well as the animated figure data 56 of FIG. 2, the ride vehicle data 58 of FIG. 2, the show effect data 60 of FIG. 2, and/or the environment data 62 of FIG. 2, to determine the textile position in real time and/or at the future time.

It should be appreciated the media controller 32 may use timing information to provide a show effect presentation. For example, timing information may include a show performed by the animated FIG. 16 (e.g., a series of movements; a motion profile that defines an order and timing of the series of movements) and/or a ride cycle of the one or more ride vehicles 42 of FIG. 1 (e.g., a ride profile that defines timing at which the one or more ride vehicles 42 travel by the show element 14 to enable guests to view the show element 14, such as periodically, such as every five, ten, fifteen, twenty, twenty-five, or thirty seconds).

In an embodiment, the media controller 32 may be configured to and/or may be initially programmed to use the timing information to control the animated FIG. 16 to perform the show (e.g., repeat the show) for each of the one or more ride vehicles 42 as the one or more ride vehicles 42 travel by the show element 14. In an embodiment, the media controller 32 may receive and/or utilize sensor data that indicates the timing information, such as initiation of the show and/or presence of the one or more ride vehicles approaching the show element 14. In any case, the projection mapping system 12 may dynamically project the imagery onto the textile 24 of the show element 14 during each show of the show element 14 (e.g., even though movement of the animated FIG. 16 may be the same, the textile 24 may move in a different manner during each show, and thus, the media controller 32 may estimate the current textile position at the current time and/or predict the future textile position at the future time as described herein). For example, the media controller 32 may estimate the current textile position at the current time and instruct projection of the imagery according to the current textile position at the current time, which may be useful when the textile 24 is expected to be stationary in the current textile position (e.g., after motion of the animated FIG. 16 to assume a new position). For example, the media controller 32 may estimate the future textile position at the future time and instruct projection of the imagery according to the future textile position at the future time, which may be particularly useful when the textile 24 is expected to be moving through space and changing its textile position (e.g., during motion of the animated FIG. 16 to reach the new position). In an embodiment, the media controller 32 may determine (e.g., continuously, periodically, and/or responsive to events, such as motion of the animate FIG. 16) use both an estimate of the current textile position and also a prediction of the future textile position to determine appropriate timing and content for projection of the imagery.

It should be appreciated that the textile 24 may be loosely draped over the animated FIG. 16. Thus, at least one portion of the textile 24 may hang freely from the animated FIG. 16 and/or is not fitted to the animated FIG. 16. For example, at least one portion of the textile 24 may not follow (e.g., match; show) a contour of the body 20 of the animated FIG. 16 and/or may not provide a snug fit about the body 20 of the animated FIG. 16. For example, at least one portion of the textile 24 may include extra (e.g., excess) fabric, such as fabric that hangs from the animated FIG. 16. The textile 24 may not be an elastic (e.g., spandex) bodysuit form, but instead may include at least a fabric that drapes (e.g., hangs, flows) relative to the animated FIG. 16 and may have characteristics (e.g., weight) that facilitate this draping behavior of the textile 24. Further, in an embodiment, the textile 24 may not be connected or attached to the animated FIG. 16, and the textile 24 may move (e.g., shift, bunch, form various shape features) as the animated FIG. 16 moves underneath and/or while wearing the flowable textile 24.

Advantageously, disclosed embodiments enable projection mapping onto any of a variety of flowable textiles (e.g., flexible textiles; the textile 24 of FIGS. 1 and 3). The flowable textiles may move freely and/or in a variety of manners when subjected to various forces, such as an air flow, a pulling force, and/or a pushing force. For example, the flowable textiles may move and/or form various shape features (e.g., peaks, valleys, folds, wrinkles) due to movement of the body 20 of the animated FIG. 16 and/or air flow in a vicinity of the flowable textiles, and characteristics (e.g., type, size, and/or location) of the shape features may vary based on the movement of the body 20 of the animated FIG. 16 and/or the air flow and/or other factors. Indeed, as noted herein, the characteristics of the shape features may vary even in presence of a same or similar force provided at different times (e.g., a same air flow provided at different times; a same pulling force provided at different times; a same pushing force provided at different times; forces due to a same movement of the animated FIG. 16 at different times). As such, disclosed embodiments may dynamically adapt to the textile position in real time and/or dynamically predict the future textile position at the future time, such as to account for the various and complex shape features that may appear in the flowable textile. Thus, an authenticity and realism of the projection mapping may be improved when imagery is projected onto the flowable textiles.

In an embodiment, the projection mapping system 12 may also include one or more additional trackers (e.g., having features of the one or more trackers 26) that are integrated into and/or coupled to the animated FIG. 16. The projection mapping system 12 may also include one or more additional detectors (e.g., having features of the one or more detectors 30) and/or utilize the one or more detectors 30 to track the one or more additional trackers. Further, the media controller 32 may process signals from the one or more additional detectors and/or the one or more detectors 30 to determine a respective position of the animated FIG. 16 (e.g., at least a portion of the animated FIG. 16, such as a head and/or a face of the animated figure; in real time and/or at the future time). Further, the projection mapping system 12 may also include one or more one or more additional projectors (e.g., having features of the one or more projectors 28) and/or utilize the one or more projectors 28 to project additional imagery onto the animated FIG. 16 (e.g., at least the portion of the animated figure) based on the respective position of the animated figure. In this way, the project mapping system 12 may project the imagery onto the textile 24 and the additional imagery onto the animated FIG. 16 (e.g., simultaneously; in a coordinated manner) to provide a complex, coordinated projection show as part of the attraction system 10.

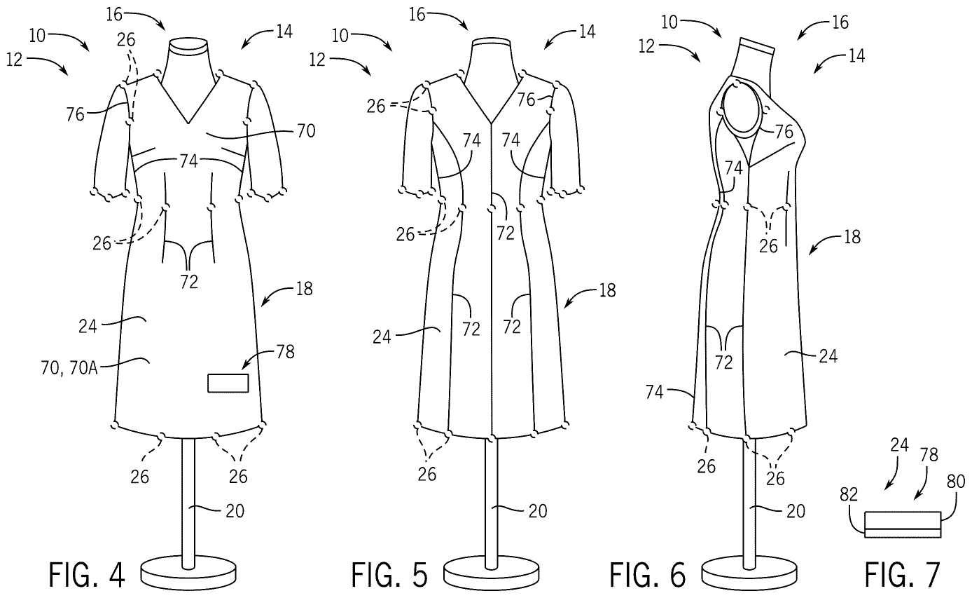

FIGS. 4-6 illustrate an embodiment of the show element 14 that may be used in the attraction system 10, wherein the textile 24 of the show element 14 includes support features. In particular, FIG. 4 is a front view of the embodiment of the show element 14 with the support features, FIG. 5 is a back view of the show element 14 with the support features, and FIG. 6 is a side view of the show element 14 with the support features. In FIG. 6, sleeve portions of the textile 24 are removed to facilitate visualization of other portions of the textile 24. As shown, the show element 14 may include the animated FIG. 16, which may include the body 20. As described with reference to FIG. 1, the animated FIG. 16 may also include the one or more actuators 22 of FIG. 2 that drive movement of the body 20. As shown, the show element 14 may include the costume 18, which may include the textile 24 and the one or more trackers 26. In FIGS. 4-6, the one or more trackers 26 are shown in dashed lines, as the one or more trackers 26 may be present on the external surface of the textile 24, on the internal surface of the textile 24, between layers of the textile 24, at the back side of the show element 14, and/or at the front side of the show element 14.

In an embodiment, it may be desirable to provide the show element 14 with the support features that provide stability to the one or more projection surfaces 70 of the textile 24. For example, the support features may provide stability to a primary projection surface 70A of the one or more projection surfaces 70 (e.g., the primary projection surface that is located at or across a bottom portion of a dress). Thus, even during movement of the body 20 of the animated FIG. 16 and/or even when the textile 24 is subjected to various forces (e.g., air flow), the support features may support the primary projection surface 70A such that the primary projection surface 70A remains relatively stable (e.g., unmoving) and/or smooth (e.g., without folds) compared to other portions of the textile 24 and/or compared to another textile without the support features. In this way, imagery projected onto the primary projection surface 70A is visible to the guests within a guest area (e.g., the guests within a seating area; the guests within a ride vehicle on a ride path; the guests walking along a walking path).

The support features may include materials, seams, and/or shapes (e.g., cuts) of the textile 24. In an embodiment, the textile 24 may include layers of materials. For example, FIG. 7 is a cross-sectional view of an embodiment of a portion 78 of the textile 24 of the show element 14 of FIG. 4. In FIG. 7, the cross-sectional view of the portion 78 of the textile 24 is taken in a horizontal plane through the textile 24. In an embodiment, the layers of materials may include a first layer 80 (e.g., that contacts and/or is proximate to the body 20 of the animated FIG. 16, that is not visible to the guests, and/or that does not display the imagery) and a second layer 82 (e.g., that overlays the first layer 80, that is visible to the guests, and/or that displays the imagery). It should be appreciated that FIG. 7 is intended to be generally representative of and/or show a schematic representation of the first layer 80 and the second layer 82 relative to one another. However, the first layer 80 and the second layer 82 may have any suitable respective thickness (e.g., the first layer 80 may be two, three, four, or more times thicker than the second layer 82), respective geometry (e.g., overall curvature, such as across the portion 78), contact surface area between the first layer 80 and the second layer 82 (e.g., separation from one another, such as across the portion 78), and so forth. The first layer 80 and the second layer 82 may extend together (e.g., be layered) across an entirety of the textile 24 or only some of the textile 24 (e.g., the bottom portion of the dress).

The first layer 80 may be a first material, and the second layer 82 may be a second material, wherein the first material is different than the second material. The first material may be more elastic, resilient, thicker, and/or more structured than the second material. For example, the first layer 80 may be thicker than the second layer 82 as shown in FIG. 7 (e.g., in the cross-sectional view). In an embodiment, the first material may be a synthetic rubber material (e.g., neoprene) and/or a synthetic polymer material (e.g., polyurethane-based elastomer, spandex, elastane), and the second material may be a flowable material (e.g., relatively flowable compared to the first material; a fabric that drapes and hangs loosely; natural and/or synthetic woven fabric; cotton; polyester; blended fabric). For example, when subjected to a force (e.g., air flow, pulling force, and/or pushing force; when placed together on the animated FIG. 16 and/or when separated from one another and separately subjected to the force), the first material may demonstrate less movement (e.g., change to its configuration, shape, surface) than the second material. Additionally or alternatively, when subjected to the force, the first material may demonstrate greater return to its shape (e.g., prior or initial shape) than the second material. In this way, the first material may support the second material and facilitate stability of the one or more projection surfaces 70, such as at least the primary projection surface 70A. The second material may also have characteristics that enable the second material to provide the one or more projection surfaces 70. For example, the second material may have a color (e.g., light color, such as light gray or white), a smoothness (e.g., low roughness value), and/or other characteristics that support desirable (e.g., sufficiently clear) display of projected imagery on the second material.

It should be appreciated that at least a portion of the first layer 80 and/or at least a portion of the second layer 82 may not follow the contour of the body 20 of the animated FIG. 16, but instead may hang freely from the animated FIG. 16, as described herein. In an embodiment, the first layer 80 and the second layer 82 are not affixed to one another (e.g., are not fastened to one another). Instead, in an embodiment, the first layer 80 and the second layer 82 may be cut with corresponding forms (e.g., same, identical, and/or similar forms), and then the second layer 82 may be draped over the first layer 80. In an embodiment, the first layer 80 and the second layer 82 may be flatlined together (e.g., limited sewn or seamed connections, such as not at the primary projection surface 70A and/or on opposite lateral sides and not along the center of the bottom portion of the dress). In this way, at least portions of the second layer 82 may move relative to the first layer 80, which may allow the first layer 80 to provide stability to the second layer 82 and also enable the second layer 82 to provide a realistic appearance of the textile 24 from a perspective of the guests.

The support features may also include seams 72, contours 74, openings 76, and/or other fabric features (e.g., shape, tension lines) with particular placement. For example, the seams 72 may extend along a length (e.g., an entirety of the length; a majority of the length) on the back side of the textile 24 and/or along a reduced length (e.g., less than a majority of the length) on the front side of the textile 24. The seams 72 on the front side of the textile 24 may not extend into or across the primary projection surface 70A, which may facilitate clarity of the imagery at the primary projection surface 70A. The seams 72 and/or the contours 74 may provide directional pull (e.g., tensioning), such as to form a waistline and/or a flare (e.g., at a bottom edge of a bottom portion of the dress). As such, the seams 72 and/or the contours 73 may facilitate stability of the primary projection surface 70A, such as even during movement of the body 20 of the animated FIG. 16.

Further, the openings 76 may be designed (e.g., sized and/or placed) to facilitate stability of the primary projection surface 70A during expected movement of the body 20 of the animated FIG. 16. For example, the openings 76 may be oversized and placed rearward (e.g., as shown in FIG. 6) to facilitate stability of the primary projection surface 70A during expected movement of the arms of the body 20 of the animated FIG. 16. Thus, while the textile 24 may move (e.g., the one or more trackers 26 and/or the portions of the textile 24 coupled thereto may move several centimeters or more), the one or more projection surfaces 70 (e.g., at least the primary projection surface 70A) may be supported and stabilized by the support features. As such, and as described herein, the support features may facilitate tracking, determination and/or prediction of textile position, and/or provide the smooth surface for projection of the imagery, for example.

While only certain features of the disclosure have been illustrated and described herein, many modifications and changes will occur to those skilled in the art. It is, therefore, to be understood that the appended claims are intended to cover all such modifications and changes as fall within the true spirit of the disclosure. It should be appreciated that any features shown and described with reference to FIGS. 1-6 may be combined in any suitable manner. For example, the textile 24 of FIG. 3 may include multiple layers (e.g., the first layer 80 and the second layer 82) and/or other support features as described with respect to FIGS. 4-6.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. An attraction system, comprising:
a show element, comprising:
a body;
a textile that covers at least a portion of the body; and
a plurality of trackers coupled to the textile;
a processing system comprising one or more processors; and
memory storing instructions executable by the processing system to cause the processing system to:
process tracking data to determine respective positions of the plurality of trackers; and
instruct a projector to project image data onto the textile based on the respective positions of the plurality of trackers.

2. The attraction system of claim 1, wherein the textile is draped over the body to cover at least the portion of the body.

3. The attraction system of claim 1, wherein the instructions are executable by the processing system to cause the processing system to:
determine a current position of the textile based on the respective positions of the plurality of trackers; and
instruct the projector to project the image data onto the textile based on the current position of the textile.

4. The attraction system of claim 3, wherein the instructions are executable by the processing system to cause the processing system to utilize one or more machine learning algorithms to determine the current position of the textile based on the respective positions of the plurality of trackers.

5. The attraction system of claim 1, wherein the instructions are executable by the processing system to cause the processing system to:
predict a future position of the textile based on the respective positions of the plurality of trackers; and
instruct the projector to project the image data onto the textile based on the predicted future position of the textile.

6. The attraction system of claim 5, wherein the instructions are executable by the processing system to cause the processing system to:
process additional data indicative of operation of a ride vehicle; and
predict the future position of the textile based on the respective positions of the plurality of trackers and the additional data.

7. The attraction system of claim 5, wherein the instructions are executable by the processing system to cause the processing system to:
process additional data indicative of operation of an environmental system; and
predict the future position of the textile based on the respective positions of the plurality of trackers and the additional data.

8. The attraction system of claim 5, wherein the instructions are executable by the processing system to cause the processing system to:
process additional data indicative of operation of an additional show element; and
predict the future position of the textile based on the respective positions of the plurality of trackers and the additional data.

9. The attraction system of claim 5, wherein the instructions are executable by the processing system to cause the processing system to utilize one or more machine learning algorithms to predict the future position of the textile based on the respective positions of the plurality of trackers.

10. The attraction system of claim 1, wherein the image data is configured to provide an illusion of a costume change for the show element.

11. The attraction system of claim 1, comprising one or more detectors configured to detect the plurality of trackers and to generate the tracking data.

12. The attraction system of claim 1, wherein the plurality of trackers are not visible from a guest area on a front side of the show element, and the projector is configured to project the image data onto the textile on the front side of the show element such that the image data is visible from the guest area.

13. An attraction system, comprising:
a processing system comprising one or more processors; and
memory storing instructions that are executable by the processing system to cause the processing system to:
process tracking data to determine respective positions of a plurality of trackers coupled to a flowable textile of a show element;
determine a configuration of the flowable textile based on the respective positions of the plurality of trackers; and
instruct a projector to project image data onto the flowable textile based on the determined configuration of the flowable textile.

14. The attraction system of claim 13, comprising a body and the flowable textile, wherein the flowable textile is configured to be draped over or suspended from the body to form at least a portion of the show element.

15. The attraction system of claim 13, wherein the instructions are executable by the processing system to cause the processing system to utilize one or more machine learning algorithms to determine the configuration of the flowable textile based on the respective positions of the plurality of trackers.

16. The attraction system of claim 13, wherein the instructions are executable by the processing system to cause the processing system to:
receive additional data indicative of operation of a ride vehicle, a show element, an environmental system, or any combination thereof; and
determine the configuration of the flowable textile based on the respective positions of the plurality of trackers and the additional data.

17. A method, comprising:
receiving, via one or more processors, tracking data from a plurality of trackers coupled to a flowable textile, one or more detectors configured to detect the plurality of trackers coupled to the flowable textile, or both;
determining, via the one or more processors, respective positions of the plurality of trackers based on the tracking data;
determining, using the one or more processors, a configuration of the flowable textile based on the respective positions of the plurality of trackers; and
instructing, using the one or more processors, a projector to project image data onto the flowable textile based on the determined configuration of the flowable textile.

18. The method of claim 17, comprising inputting, via the one or more processors, the tracking data, the respective positions of the plurality of trackers, or both into one or more machine learning algorithms to result in the determining the configuration of the flowable textile based on the respective positions of the plurality of trackers.

19. The method of claim 17, comprising instructing, via the one or more processors, the projector to project the image data onto the flowable textile based on the determined configuration of the flowable textile to enable one or more guests in a guest area to view the image data on the flowable textile.

20. The method of claim 17, comprising instructing, via the one or more processors, the projector to project the image data onto the flowable textile based on the determined configuration of the flowable textile and in coordination with a story line of an attraction.
